(19) United States
(12) Patent Application Publication
(10) Pub. No.: US 2010/0255889 A1
(43) Pub. Date: Oct. 7, 2010

(54) PORTABLE APPARATUS AND DISPLAY CONTROL METHOD THEREOF

(75) Inventors: Makiko Tsutsui, Kawasaki (JP); Hideaki Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/818,703

(22) Filed: Jun. 18, 2010

Related U.S. Application Data
(63) Continuation of application No. PCT/JP2007/075148, filed on Dec. 27, 2007.

(51) Int. Cl. H04W 88/02

(52) U.S. Cl. 455/566

(57) ABSTRACT

A portable apparatus includes a housing unit capable of swinging; a displaying unit installed in the housing unit, the displaying unit displaying a displaying screen of an application that is currently started up; a swing state detecting unit detecting a swing state of the displaying unit; a swing starting up setting unit being set therein with an application to be started up by one of or both of the swings to left and right and the display information thereof; and a control unit that, during starting up of a first application, starts up a second application set in the swing starting up setting unit based on detection information indicative of the swing state of the displaying unit detected by the swing state detecting unit, the control unit changing display on the displaying unit from display before the swing to display of the second application started up after the swing.

This application is a continuation of International Application No. PCT/JP2007/075148, filed on Dec. 27, 2007, now pending, herein incorporated by reference.

### FIELD

Embodiments discussed in the present invention are related to display control based on a swing operation of a displaying unit that a user may swing to the right or the left, and related to a portable apparatus including the displaying unit that swings to the right or the left, and a display control method thereof.

### BACKGROUND

Portable apparatuses conventionally include: that of a folding type whose two housing units may be folded at a hinge unit; that of a sliding type whose housing unit may be slid by a sliding mechanism; that of a biaxial-hinge type whose housing unit is opened, closed, and rotated using a biaxial hinge; etc. A portable apparatus is also present whose display screen may be switched to screen display on a landscape-orientation wide screen by rotating the display screen by 90 degrees from a portrait-orientation screen to a landscape-orientation screen maintaining the operability of a conventional portable apparatus with portrait-orientation screen display, in order to cope with contents such as a full browser, a game of large-capacity, and a video image content that are suitable for viewing on a landscape-orientation wide screen. A larger display area may be taken in a landscape-orientation screen than a portrait-orientation screen for images of 1 Seg (one segment broadcasting) that is TV broadcasting for mobile terminals and applications of a full browser, etc., that are highly compatible with a landscape-orientation screen.

Some portable apparatuses each including a screen that may pivot (swing) from a portrait-orientation screen to a landscape-orientation screen, include one whose displaying unit may swing in one of the left and right directions or in both of the left and right directions. A portable apparatus is also present any functions of which may instantly be started up by swinging a displaying unit thereof from its standby screen (a screen displayed in its standby state where no application is executed) displayed on the displaying unit. Though swinging in only one direction starts up only one function, two functions may be selectively used by allocating one function to each of the right and left directions when swinging in both of the right and the left directions is enabled.

A portable apparatus is also present that may start up a specific application (for example, reception of 1 Seg broadcasting) by being swung not only from its standby screen but also during use of an application.

The lateral width of a portrait-orientation displaying unit with its display screen in the landscape orientation becomes substantially two times as large as that in the portrait orientation. For example, using a display screen of 432 [dots]×240 [dots], the screen becomes a landscape-orientation screen of 240 [dots]×432 [dots] when the displaying unit is swung to display its landscape-orientation screen. An application display of 240 [dots]×240 [dots] may relatively easily be executed by only shrinking the longitudinal width to 240 [dots] without changing the lateral width of an application screen displayed on the portrait-orientation screen, and the remaining portion of 240 [dots]×192 [dots] may be allocated to separate display. In this case, a screen of received images of 1 Seg broadcasting and a screen of e-mail are concurrently displayed in one-screen display and, thereby, viewing of 1 Seg broadcasting and checking, etc., of e-mail may be executed.

Concerning such display control of a portable apparatus, Japanese Laid-Open Patent Publication No. 2000-307768 discloses that: an application is selected using a key input unit; a display developing process is executed based on information on a display orientation set in the application; and, in the display developing process, display development data is longitudinally or laterally displayed on a displaying unit according to portrait-orientation display management or landscape-orientation display management (Abstract, FIG. 1, etc.).

Japanese Laid-Open Patent Publication No. 2006-19925 discloses a portable apparatus that includes: a first housing and a second housing that may be opened and closed; and a configuration that enables a shift in one rotation operation from any one of a closed state where the second housing covers the entirety of an operating unit of the first housing and an opened state where the second housing exposes the operating unit and become bilaterally symmetrical for the central line of the first housing, to the other state, as a rotating joining mechanism with which operations may be executed with one hand to shift from its closed state to its opened state (Abstract, FIG. 1, etc.).

Concerning changing the switching of the longitudinal display and lateral display of a liquid crystal display screen for each operation mode, Japanese Laid-Open Patent Publication No. 2005-318164 discloses that the liquid crystal display screen is switched between its portrait-orientation display and its landscape-orientation display based on a detection state of a portable apparatus in a first operation mode and based on designation of switching by a user in a second operation mode (Abstract, FIG. 12, etc.).

A conventional portable apparatus that enables the swing operation only switches its display from display of an application currently operating to full-screen display in a landscape-orientation screen, or only starts up a specific application even when the swing operation is executed. To start up an application that is needed by a user, operations are necessitated to select a menu from a standby screen and shift the stand by screen to the desired application and the user is forced to execute such troublesome operations.

As to such problem, no suggestions and no disclosures thereof are included in Japanese Laid-Open Patent Publications Nos. 2000-307768, 2006-19925 and 2005-318164 and no disclosure of solving means therefor are also included.

### SUMMARY

According to an aspect of the embodiments of the invention, a portable apparatus that is capable of concurrently executing two or more applications includes a housing unit that is capable of swinging to left or right; a displaying unit that is installed in the housing unit, the displaying unit displaying a displaying screen of an application that is currently started up; a swing state detecting unit that detects a swing state of the displaying unit; a swing starting up setting unit that is set therein with an application to be started up by one of or both of the swings to the left and the right, and the display information of the application; and a control unit that, during starting up of a first application, starts up a second application set in the swing starting up setting unit based on detection information that is indicative of the swing state of the displaying unit detected by the swing state detecting unit, the control unit changing display on the displaying unit from display before the swing to display of the second application started up after the swing.

According to another aspect of the embodiments of the invention, a display control method of a portable apparatus that is capable of concurrently executing two or more applications includes setting an application to be started up by one of or both of swings to left and right, and display information of the application; swinging a displaying unit that displays a display screen of an application currently started up; detecting a swing state; and starting up, while a first application is started up, a second application set, based on detection information that is indicative of the swing state, and changing from a display screen before the swing to a display screen of the second application started up after the swing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features, and advantages of the embodiments of the present invention will become more apparent with reference to the accompanying drawings and the embodiments herein.

### BRIEF DESCRIPTION OF DRAWINGS

FIG. 1 is a diagram of a portable apparatus according to a first embodiment;

FIG. 2 is a diagram of the data configuration of a swing starting up setting area;

FIG. 3 is a diagram of the basic configuration of the portable apparatus;

FIG. 4 is a diagram of the appearance of the portable apparatus;

FIG. 5 is a flowchart of a process procedure of display control according to the first embodiment;

FIGS. 6A and 6B are diagrams of starting up of applications and switching of display by a left swing;

FIGS. 7A and 7B are diagrams of starting up of applications and switching of display by a right swing;

FIG. 8 is a diagram of a portable apparatus according to a second embodiment;

FIG. 9 is a diagram of the data configurations of a swing starting up setting area and a swing screen display setting area;

FIG. 10 is a flowchart of a process procedure of display control according to the second embodiment;

FIGS. 11A, 11B, and 11C are diagrams of starting up of applications and switching of display by a left swing;

FIGS. 12A, 12B, and 12C are diagrams of starting up of applications and switching of display by a right swing;

FIG. 13 is a diagram of storage information of the swing starting up setting area according to a first example;

FIG. 14 is a flowchart of a process procedure according to the first example;

FIGS. 15A, 15B, and 15C are diagrams of starting up of applications and switching of display by a left and a right swings;

FIGS. 16A and 16B are diagrams of switching of a full browser from its portrait-orientation screen display to its landscape-orientation screen display;

FIGS. 17A and 17B are diagrams of switching of e-mail received from its landscape-orientation full screen display to portrait-orientation screen display;

FIG. 18 is a diagram of storage information of a swing starting up setting area and a swing screen display setting area according to a second example;

FIG. 19 is a flowchart of a process procedure according to the second example;

FIGS. 20A, 20B, and 20C are diagrams of starting up of applications and switching of display by a left and a right swings;

FIGS. 21A and 21B are diagrams of two-screen display and portrait-orientation screen display;

FIG. 22 is a diagram of storage information of a swing starting up setting area and a swing screen display setting area according to a third example;

FIG. 23 is a flowchart of a process procedure according to the third example;

FIGS. 24A, 24B, and 24C are diagrams of starting up of applications and switching of display by a left and a right swings;

FIG. 25 is a diagram of two-screen display;

FIG. 26 is a diagram of starting up of applications and switching of display screens according to a fourth example; and

FIG. 27 is a diagram of starting up of applications and switching of display screens according to the fourth example.

### DESCRIPTION OF EMBODIMENTS

Each of embodiments of the present invention is a portable apparatus that is capable of concurrently executing two or more applications and that: when the portable apparatus is swung in the left or right direction during starting up of a first application, detects its swing state using a swing state detecting unit; according to a second application and display information therefor set in a swing starting up setting unit, starts up the second application and screen display corresponding to the display information; and, thereby, improves the convenience of the portable apparatus.

### First Embodiment

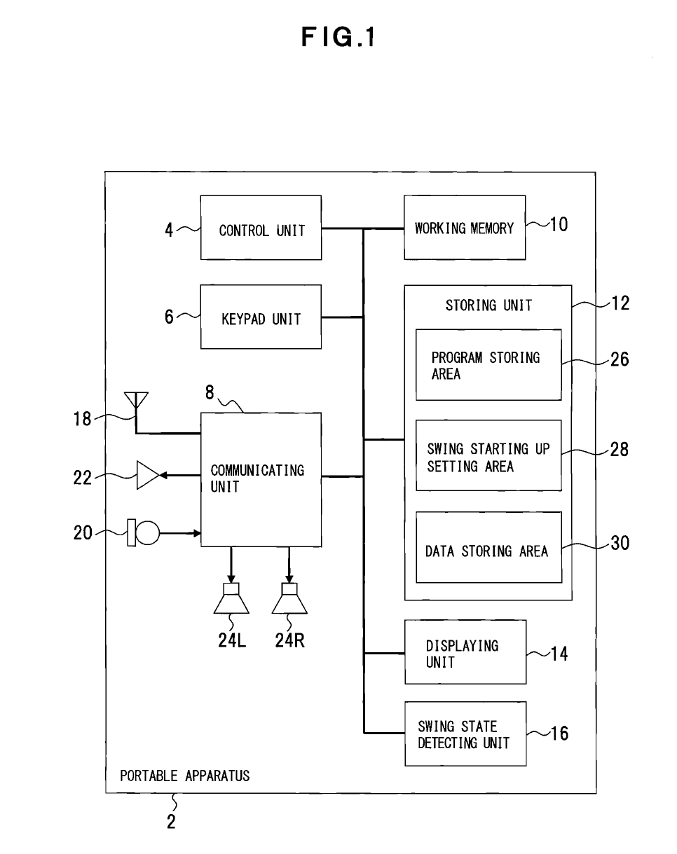

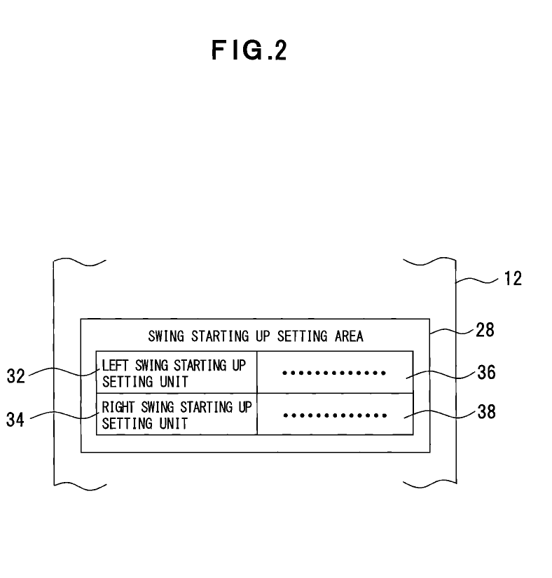

A first embodiment will be described with reference to FIGS. 1 and 2. FIG. 1 is a diagram of a portable apparatus according to the first embodiment. FIG. 2 is a diagram of the data configuration of a swing starting up setting area. The configurations depicted in FIGS. 1 and 2 are examples and the present invention is not limited to such configurations.

A portable apparatus 2 includes display means that may be swung in the right or left direction and a function of: during starting up of a first application, starting up a second application set in a swing starting up setting unit based on detection of the swing (pivoting) state; and changing display from that before the swing to that of the application started up after the swing.

The portable apparatus 2 includes a control unit 4, a keypad unit 6, a communicating unit 8, a working memory 10, a storing unit 12, a displaying unit 14, and a swing state detecting unit 16. The control unit 4 executes an OS (Operating System) and an application, input control, output control such as display control corresponding to a swing state, communication control, etc., and includes a CPU (Central Processing Unit). The keypad unit 6 is an input operating unit that is used to input information and is used to input information from a user. The control unit 4 accepts input from the keypad unit 6 during displaying two screens on the displaying unit 14 and executes a displaying process as a process of reflecting the input on a displaying screen of the displaying unit 14.

Based on control by the control unit 4, the communicating unit 8 executes communication with a base station, capturing of sounds and outputting of sounds, reception of 1 Seg broadcasting (television broadcasting for mobile terminals), etc. Therefore, the communicating unit 8 includes an antenna 18, and reception of broadcasting and transmission and reception to/from a base station are executed through the antenna 18. Sound input is input into the communicating unit 8 through a microphone 20. The sounds are output from a receiver 22. Stereo or monaural reproduced sounds of broadcasting, etc., may also be taken out from speakers 24L and 24R.

The working memory 10 develops an OS or an application to be executed and configures a working area for executing information processing. The storing unit 12: is storing means that stores therein swing starting up setting information, etc., in addition to the OS and various applications; is configured by a non-volatile memory such as a flash memory; and sets therein a program storing area 26, a swing starting up setting area 28, and a data storing area 30. The program storing area 26 is used to store the above OS, various applications, and a display control program that executes screen display corresponding to a swing. The swing starting up setting area 28 configures the swing starting up setting unit that stores therein the swing information of the displaying unit 14 and information indicative of applications and operations that correspond to the swing information. The data storing area 30 stores therein input data, etc.

The displaying unit 14 is displaying means of displaying an application and an operation state, is configured by, for example, an LCD (Liquid Crystal Display) device, and is adapted to be capable of swinging in the right and/or left direction(s). The swing state detecting unit 16 is means of detecting a swing direction (the right or left direction) and a swing position (a right or left stop position) as the swing state of the displaying unit 14, and is means of inputting state information that is indicative of the swing state. The detection information of the swing state detecting unit 16 is monitored by the control unit 4, is captured by the control unit 4, and is stored in the data storing area 30. The detection information is used to read the starting-up information set in the swing starting up setting area 28 and select an application to be started up.

As depicted in FIG. 2, the swing starting up setting area 28 sets therein a left swing starting up setting unit 32 and a right swing starting up setting unit 34. The left swing starting up setting unit 32 stores therein applications and starting-up information 36 of screen display as functions to be started up by a left swing of the displaying unit 14. The right swing starting up setting unit 34 stores therein applications and starting-up information 38 of screen display as functions to be started up by a right swing of the displaying unit 14. These pieces of starting-up information 36 and 38 only have to be adapted to be capable of being input from a starting up setting screen and set when a function setting operation is started up from a menu screen after the power of the portable apparatus 2 is turned on.

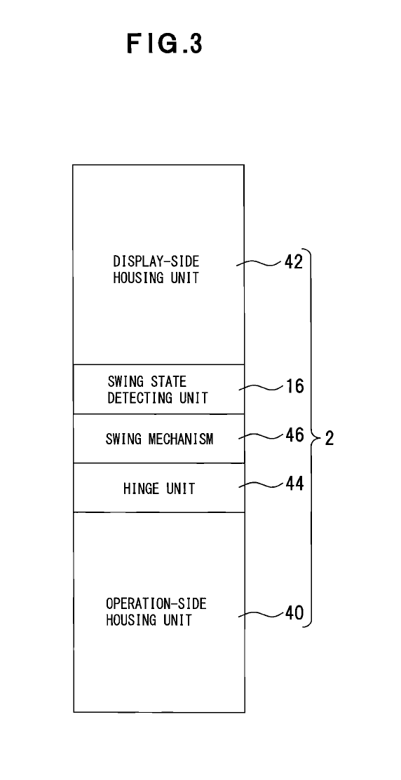

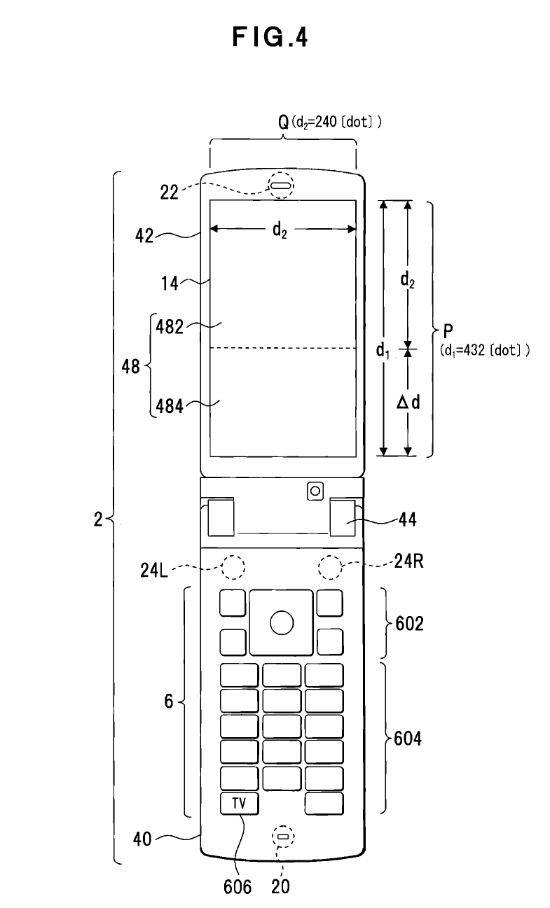

The configuration of the portable apparatus 2 will be described with reference to FIGS. 3 and 4. FIG. 3 is a diagram of the basic configuration of the portable apparatus. FIG. 4 is a diagram of the appearance of the portable apparatus. The configurations depicted in FIGS. 3 and 4 are examples and the present invention is not limited to such configurations. In FIGS. 3 and 4, the same parts as those of FIG. 1 are given the same reference numerals.

As depicted in FIG. 3, the portable apparatus 2: includes an operation-side housing unit 40 as a first housing unit, a display-side housing unit 42 as a second housing unit, and a hinge unit 44 as an opening and closing mechanism between the operation-side housing unit 40 and the display-side housing unit 42; and is installed therein with a swing mechanism 46 that holds the display-side housing unit 42 on the operation-side housing unit 40 allowing the display-side housing unit 42 to pivot. The swing mechanism 46 is installed therein with the above swing state detecting unit 16 and, thereby, the swing position of the displaying unit 14 is detected.

As depicted in FIG. 4, the operation-side housing unit 40 and the display-side housing unit 42 are joined by the hinge unit 44 and are capable of being opened and closed. The operation-side housing unit 40 is installed therein with the above keypad unit 6, the microphone 20, and the speakers 24L and 24R. The display-side housing unit 42 is installed therein with the displaying unit 14 and the receiver 22. The displaying unit 14 includes a displaying screen 48. The keypad unit 6 is disposed thereon with cursor keys 602, character keys 604, a TV key 606, etc. The TV key 606 is an example of a function switching key and is used for switching a TV reception screen mode. The TV key 606 is allocated with a function of switching to starting reception of 1 Seg broadcasting and 1 Seg broadcasting landscape-orientation full screen display, from 1 Seg broadcasting landscape-orientation full screen display to two-screen display, and from the two-screen display to another screen display. Key input for each of the above is entered sequentially into the control unit 4 and, thereby, starting of reception of broadcasting and switching of display are executed.

On the displaying screen 48 of the displaying unit 14, the number of dots d₁ on a long side P is, for example, d₁=432 [dots] and the number of dots d₂ on a short side Q is, for example, d₂=240 [dots].

In this case, the difference Δd between the number of dots d₁ on the long side P and the number of dots d₂ on the short side Q is as follows.

Δd=d₁−d₂=192 [dots] (1)

The long side P of the displaying screen 48 is divided into two that are d₂ and Δd. That is, the displaying screen 48 may be divided into: a square displaying area 482 whose number of dots on one side is 240 [dots] and that has d₂×d₂=240 [dots]×240 [dots]; and a rectangular displaying area 484 that has d₂×Δd=240 [dots]×192 [dots] and, thereby, two-screen display is enabled.

In the above screen display: the case where the entirety of the displaying screen 48 is used to display a single application is referred to as “full screen”, “full screen display”, or “full screen starting up”; and the case where the displaying screen 48 is divided into, for example, the displaying areas 482 and 484 as two areas and each of these areas is used to display an independent application (the same application or a different application) is referred to as “two screens”, “two-screen display”, or “two-screen starting up”. Any areas may be set for the two-screen display. The above displaying areas 482 and 484 are examples and the two-screen display is not limited to such divided display.

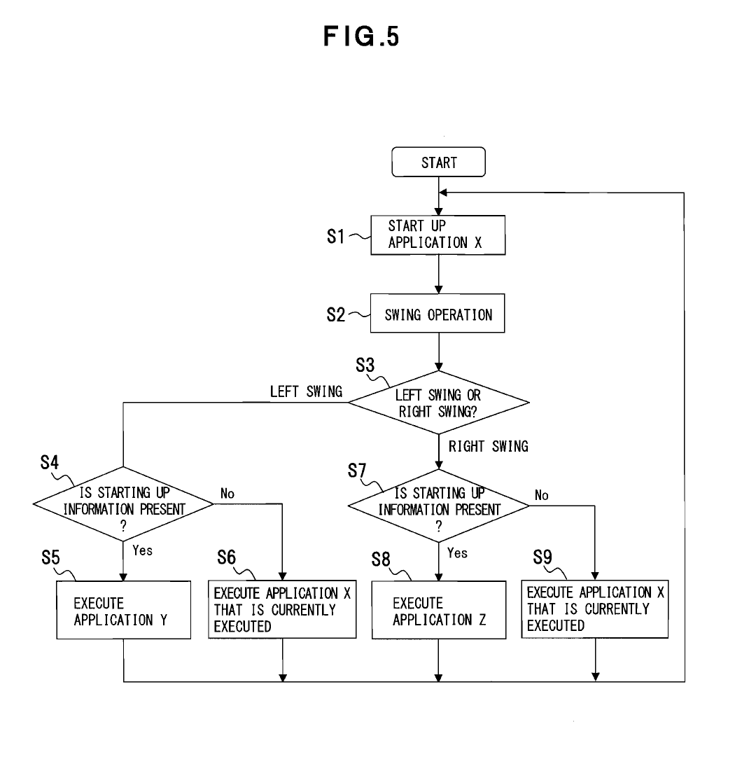

Starting up of applications and display control will be described with reference to FIG. 5. FIG. 5 is a flowchart of a process procedure of display control according to the first embodiment. The process procedure of FIG. 5 is an example and the present invention is not limited to this process procedure.

This process procedure is an example of a display control method or a display control program of the portable apparatus. The process procedure includes a process that is based on the settings of starting up information of the swing starting up setting area 28 (FIG. 2). That is, the switching of display based on the starting up information is executed in response to a swing operation.

According to the process procedure, as depicted in FIG. 5, for example, an application X as a first application is started up; during the starting up (step S1), a swing operation of the display-side housing unit 42 is executed (step S2); and swing starting up is executed based on the detection information of the swing state detecting unit 16. Whether the swing operation is a left swing or a right swing is determined from the detection information of the swing state detecting unit (step S3). When the swing operation is a left swing (LEFT SWING of step S3), whether starting up information being set is present is determined (step S4).

When starting up information of, for example, an application Y as a second application is set (YES of step S4), the application Y is executed based on the starting up information and a full screen of the application Y is developed on the displaying screen 48 (step S5).

When no starting up information of any application is set (NO of step S4), a full screen of the application X that is currently started up is developed on the displaying screen 48 (step S6).

When the swing operation is a right swing at step S3, (RIGHT SWING of step S3), whether starting up information being set is present is determined also for the right swing (step S7).

When starting up information of, for example, an application Z as another second application is set (YES of step S7), the application Z is executed based on the starting up information and a full screen of the application Z is developed on the displaying screen 48 (step S8).

When no starting up information of any application is set (NO of step S7), the full screen of the application X that is currently started up is developed on the displaying screen 48 (step S9).

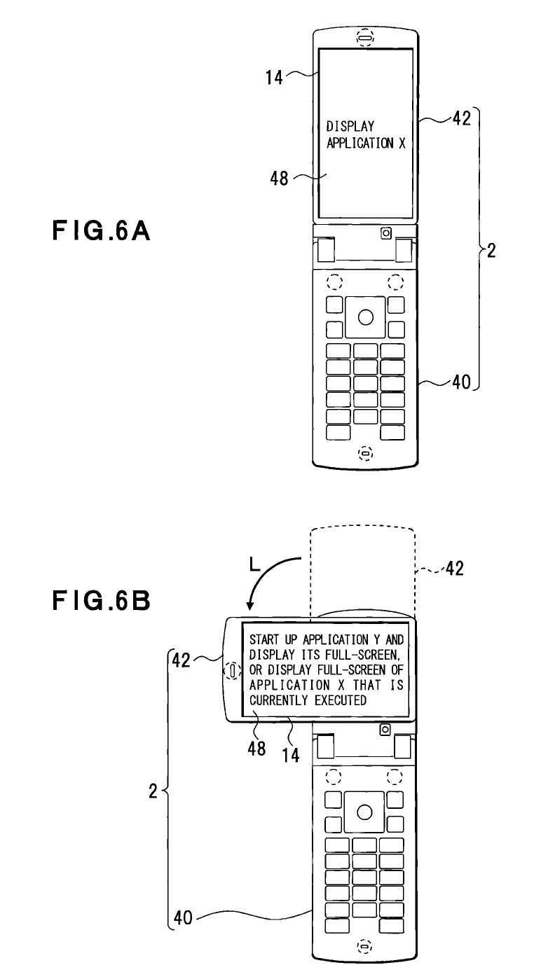

As to such switching of display in response to the swing of the displaying unit 14, when the display-side housing unit 42 is swung to the left (L) as depicted in FIG. 6B from the state where the display of the application X that is currently executed is developed on the displaying screen 48 as depicted in FIG. 6A, the application Y is started up on the displaying screen 48 based on the starting up information and full-screen display of the application Y is developed. When no starting up information is set, the full-screen display of the application X that is currently started up is developed on the displaying screen 48.

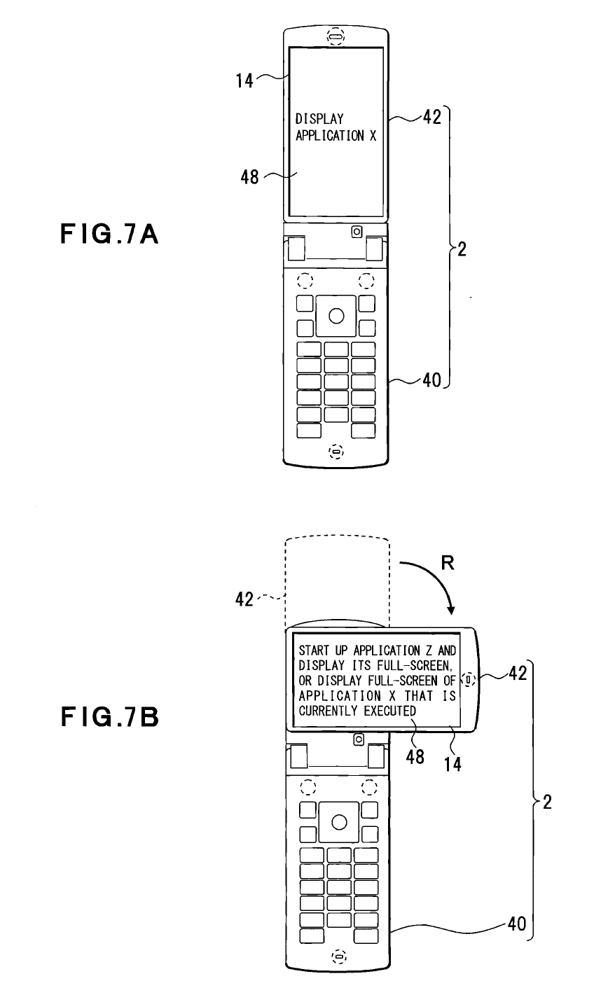

When the display-side housing unit 42 is swung to the right (R) as depicted in FIG. 7B from the state where the display of the application X that is currently executed is developed on the displaying screen 48 as depicted in FIG. 7A, the application Z is started up on the displaying screen 48 based on the starting up information and full-screen display of the application Z is developed on the displaying screen 48. When no starting up information is set, the full-screen display of the application X that is currently started up is developed on the displaying screen 48.

As above, in the case where the starting up of the application Y is designated to be caused by a left swing in the swing starting up settings, when the display-side housing unit 42 is swung to the left during the displaying of the application X (an application other than the application Y) on the portrait-orientation screen, the application Y may be started up and the full-screen display of the application Y may be executed.

In the case where the starting up of the application Z is designated to be caused by a right swing in the swing starting up settings, when a right swing is executed during the displaying of the application X (an application other than the application Z) on the portrait-orientation screen, the application Z may be started up and the full-screen display of the application Z may be executed.

### Second Embodiment

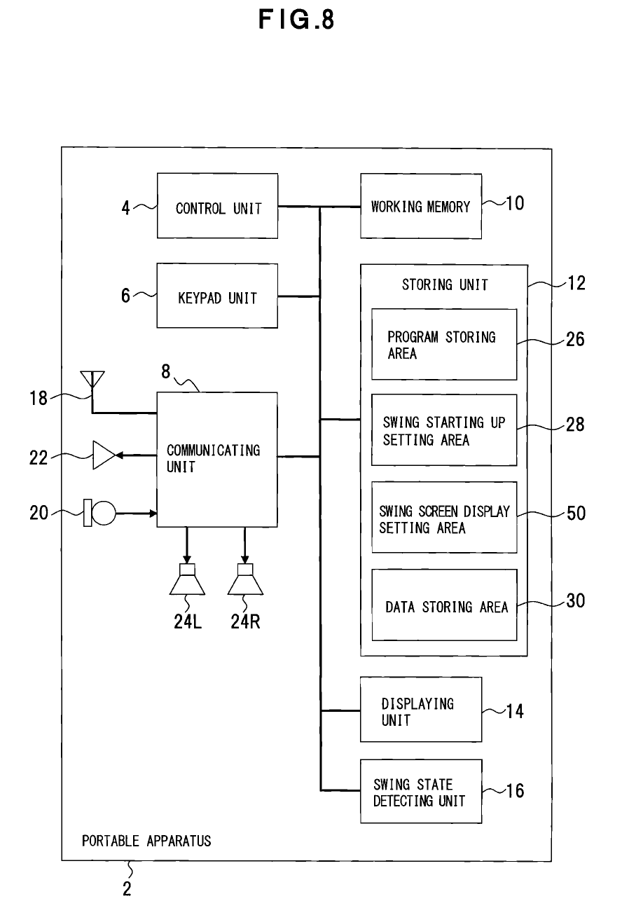

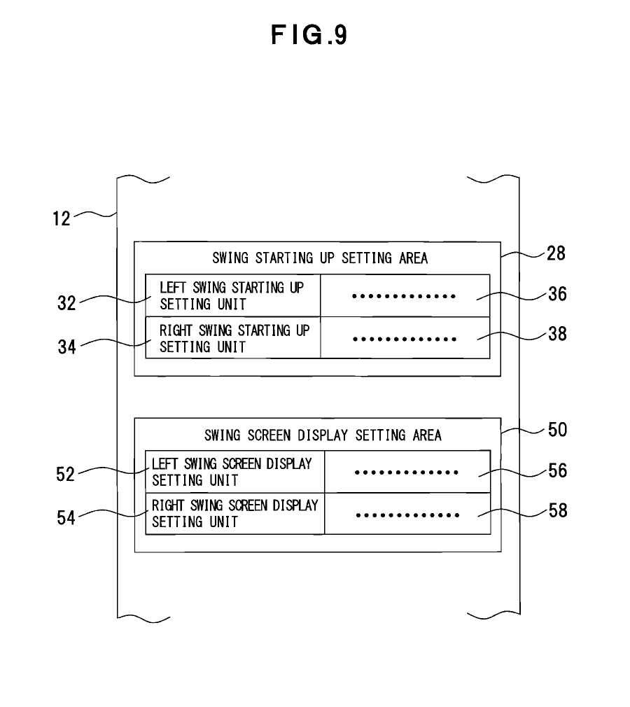

A second embodiment will be described with reference to FIGS. 8 and 9. FIG. 8 is a diagram of a portable apparatus according to the second embodiment. FIG. 9 is a diagram of the data configurations of a swing starting up setting area and a swing screen display setting area. The configurations depicted in FIGS. 8 and 9 are examples and the portable apparatus and the data configurations are not limited to such configurations. In FIGS. 8 and 9, the same parts as those of FIGS. 1 and 2 are given the same reference numerals.

The portable apparatus 2 of the embodiment is installed therein with displaying means that may be swung to the left or right, setting means to set functions for swing starting up, and setting means to set screen display forms, separating these three from each other. Thereby, during the starting up of the first application, starting up of the second application set in the swing starting up setting means is enabled based on detection of a swing (pivoting) state, and applications to be executed and the display screen forms are enabled to be freely designed such as a function of changing the display of the application started up after the swing from the display before the swing to the two-screen display.

In the embodiment, the storing unit 12: is storing means that stores therein the swing starting up setting information, the swing screen display setting information, etc., in addition to the OS and various applications; is configured by a non-volatile memory such as a flash memory; and, as depicted in FIG. 8, sets therein a swing screen display setting area 50 in addition to the program storing area 26, the swing starting up setting area 28, and the data storing area 30. The program storing area 26 is used to store therein the above OS, various applications, and the display control program that executes screen display corresponding to a swing. The swing starting up setting area 28 configures similarly to that of the first embodiment the swing starting up setting unit that stores therein the swing information of the displaying unit 14 and information indicative of applications and operations that correspond to the swing information. The swing screen display setting area 50 configures a swing screen display setting unit that stores therein screen display information such as the full-screen display, two-screen display of the screen display that corresponds to a swing. Other configurations are same as those of the first embodiment, therefore, are given the same reference numerals in FIG. 8, and will not again be described.

As depicted in FIG. 9, the swing screen display setting area 50 sets therein a left swing screen display setting unit 52 and a right swing screen display setting unit 54. The left swing screen display setting unit 52 stores therein screen display information 56 that is indicative of the two-screen display or the full-screen display. The right swing screen display setting unit 54 stores therein screen display information 58 that is indicative of the two-screen display or the full-screen display. These pieces of screen display information 56 and 58 only have to be adapted to be capable of being input from the starting up setting screen and set similarly to the pieces of starting up information 36 and 38 when the function setting operation is started up from the menu screen after the power of the portable apparatus 2 is turned on. The configuration of the swing starting up setting area 28 is same as that of the first embodiment, therefore, the same reference numerals are given in FIG. 9, and will not again be described.

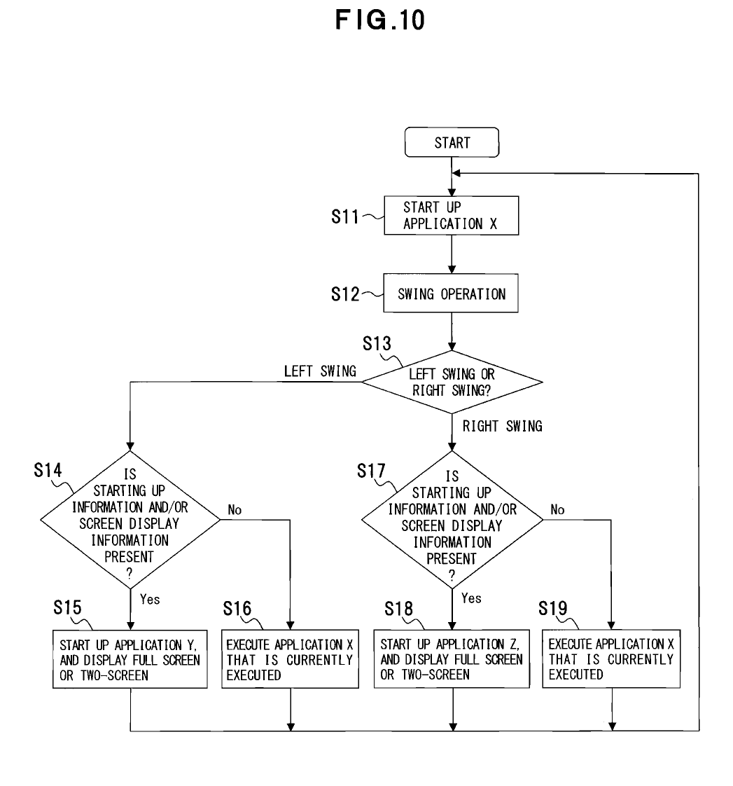

Starting up of applications and control of display will be described with reference to FIG. 10. FIG. 10 is a flowchart of a process procedure of control of display according to the second embodiment. The process procedure of FIG. 10 is an example and the present invention is not limited to this process procedure.

The process procedure is an example of the display control method or the display control program of the portable apparatus. The process procedure includes a process that is based on settings of the starting up information in the swing starting up setting area 28 and/or the screen display information in the swing screen display setting area 50. That is, switching of display based on the starting up information and/or the screen display information is executed in response to a swing operation.

According to the process procedure, as depicted in FIG. 10: the application X that is the first application is started up; during the starting up (step S11), a swing operation of the display-side housing unit 42 is executed (step S12); and the swing starting up is executed based on the detection information of the swing state detecting unit 16. Whether the swing operation is a left swing or a right swing is determined from the detection information of the swing state detecting unit 16 (step S13). When the swing operation is a left swing (LEFT SWING of step S13), whether the starting up information and/or the screen display information being set are (is) present is determined (step S14).

When the starting up information of the application Y that is the second application and the screen display information thereof are set (YES of step S14), the application Y is started up based on the starting up information and its two-screen display or its full screen is developed on the displaying screen (step S15).

When no starting up information and no screen display information of any application are set (NO of step S14), the full screen of the application X that is currently started up is developed on the displaying screen 48 (step S16).

At step S13, when the swing operation is a right swing (RIGHT SWING of step S13), whether starting up information and/or screen display information being set are (is) present is also determined for the right swing (step S17).

When the starting up information and the screen display information of the application Z that is the other second application are set (YES of step S17), the application Z is started up based on the starting up information and its two-screen display or its full screen is developed on the displaying screen 48 (step S18).

When no starting up information and no screen display information of any application are set (NO of step S17), the full screen of the application X that is currently started up is developed on the displaying screen 48 (step S19).

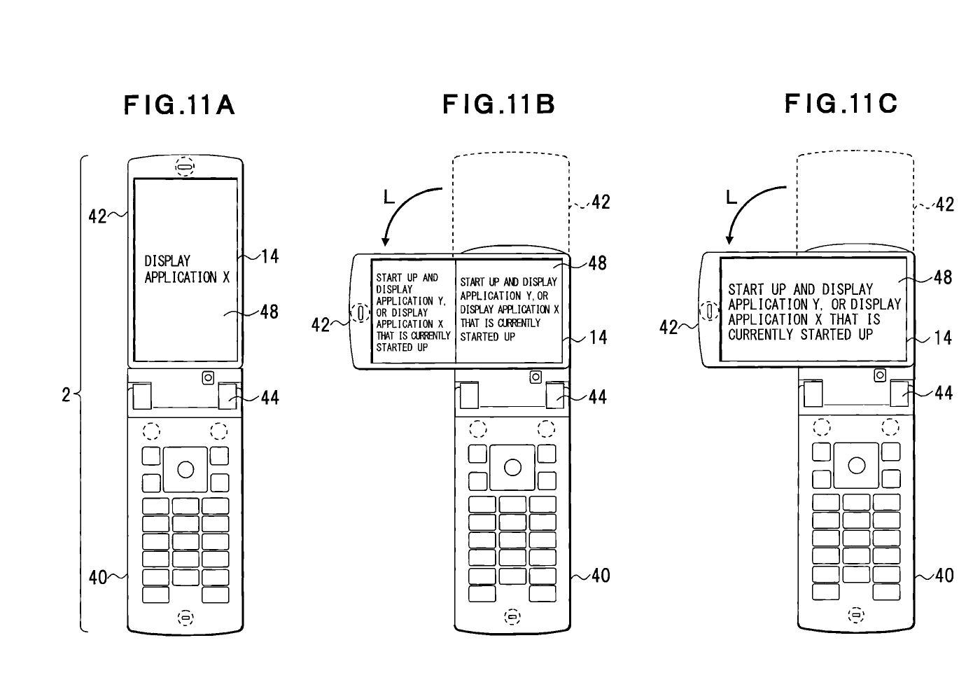

As to the switching of display in response to the swing of the displaying unit 14, when the display-side housing unit 42 is swung to the left (L) as depicted in FIG. 11B from the state where the display of the application X that is currently executed is developed on the displaying screen 48 as depicted in FIG. 11A, the application Y is started up on the displaying screen 48 based on the starting up information. In this case, when the screen display information is designation of two-screen display, two-screen display of the applications X and Y is executed. When the screen display information is designation of full-screen display or when no starting up information is set, as depicted in FIG. 11C, the full-screen display of the application Y is executed based on the screen display information or, when no starting up information is set, the full-screen display of the application X that is currently started up is executed.

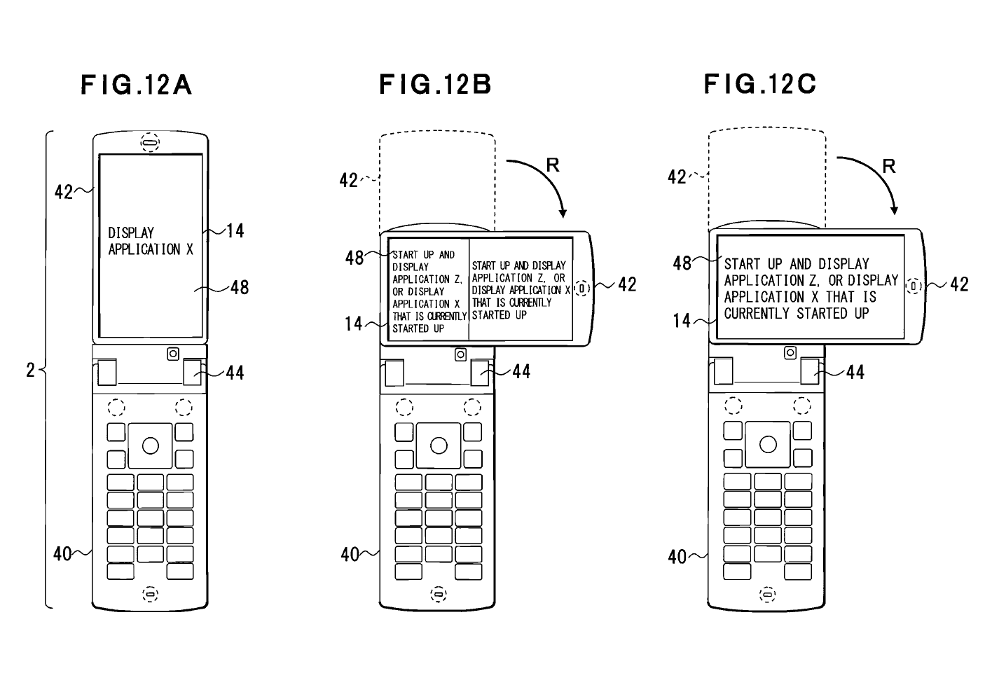

When the display-side housing unit 42 is swung to the right (R) as depicted in FIG. 12B from the state where the display of the application X that is currently executed is developed on the displaying screen 48 as depicted in FIG. 12A, the application Z is started up on the displaying screen 48 based on the starting up information. In this case, when the screen display information is designation of two-screen display, two-screen display of the applications X and Z is executed. When the screen display information is designation of full-screen display or when no starting up information is set, as depicted in FIG. 12C, full-screen display of the application Z is executed based on the screen display information or, when no starting up information is set, the full-screen display of the application X that is currently started up is executed.

As above, as to an application started up by a swing, two patterns are present that are execution of landscape-orientation full screen display and execution of two-screen display of the application and the other application that is already displayed. That is, during use of an application, one of the left and the right swing operations causes the display of applications to be used as the two-screen display (two screens of one for the application that is started up based on the swing starting up settings and one for the application that is currently started up) and the other causes the display of the application that is currently started up to be used as the landscape-orientation full-screen display.

### Other Embodiments

In the above embodiments, a portable telephone apparatus including the function of receiving 1 Seg broadcasting is exemplified as the portable apparatus 2. However, the present invention may also be applied to a PDA (Personal Digital Assistant) and a PC (Personal Computer) and is not limited to the portable telephone apparatus.

In the above embodiments, applications are exemplified as objects to be set in the swing starting up setting area 28. However, the applications may also include functions and specific operations. Information that is indicative of functions and operations may be adapted to be stored separately from the applications, and be executed.

In the above embodiments, the configuration to display two screens as the two-screen display or two-screen driving is exemplified. However, the present invention may be applied to a configuration to concurrently execute display of a plurality of screens that are three or more screens, and is not limited to the two-screen display.

### Examples

### First Example

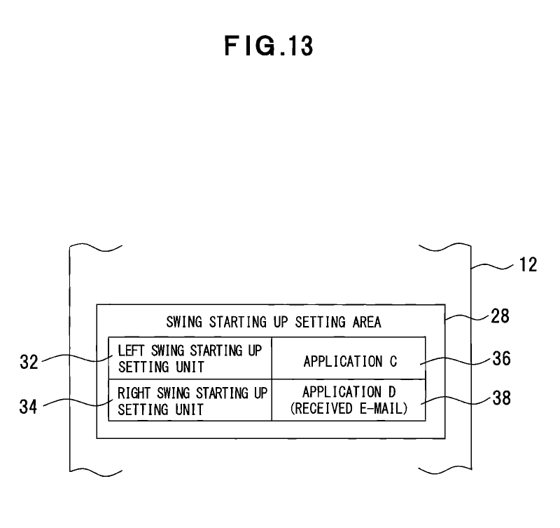

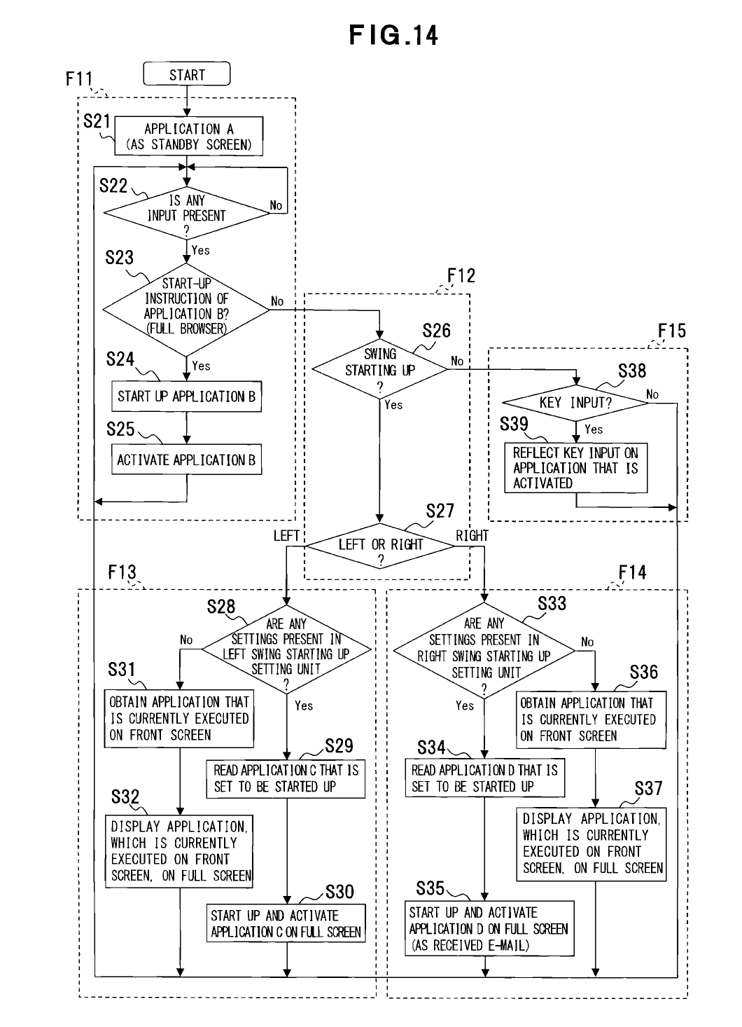

A first example will be described with reference to FIGS. 13 and 14. FIG. 13 is a diagram of storage information of a swing starting up setting area according to the first example. FIG. 14 is a flowchart of a process procedure according to the first example. Configurations depicted in FIGS. 13 and 14 are examples and the present invention is not limited to such configuration and process procedure. In FIG. 13, the same parts as those of FIG. 2 are given the same reference numerals.

A portable apparatus 2 according to the first example is the portable apparatus of the first embodiment (FIG. 1) that is embodied and the portable apparatus 2 depicted in FIG. 1 is also used in the first example. To start up an application C by a left swing, as depicted in FIG. 13, starting-up information 36 of the application C only has to be set in the left swing starting up setting unit 32 of the swing starting up setting area 28. To start up an application D (received e-mail) by a right swing, starting-up information 38 of the application D only has to be set in the right swing starting up setting unit 34. To display an application that is currently started up in the full-screen display, these pieces of starting-up information are unnecessary.

The process procedure of this example is an example of processing of the display control method and the display control program of the portable apparatus and includes, as depicted in FIG. 14: a shifting process from the application A in a standby to the application B that is the first application (process F11); a checking process of a swing operation (process F12); a starting-up process of the application C that is the second application by a swing operation to the left (process F13); a starting-up process of the application D that is another second application by a swing operation to the right (process F14); and a key input process (process F15). In the processes, the application A is, for example, a program that starts up a standby screen, etc., the application B is, for example, a full browser (software to view data and contents of files, a browser), and the application D is, for example, e-mail software.

In process F11, the application A is started up triggered by turning on the power (step S21) and a standby screen is displayed on the displaying screen 48 of the displaying unit 14. Whether any input is present from the standby screen is determined (step S22). When no input is present (NO of step S22), the standby state is maintained until any input is present. The input also includes the detection information of the swing state detecting unit 16. When some input is present (YES of step S22), whether the input is a start-up instruction of the application B is determined (step S23). When the input is the start-up instruction of the application B (YES of step S23), the application B is started up (step S24) and the application B is activated, that is, executed (step S25) and the procedure returns to step S22.

When the input at step S22 is not the start-up instruction of the application B at step S23 (NO of step S23), the procedure moves to process F12. In process F12, whether the input is swing starting up based on a swing operation is determined (step S26). When the input is the swing starting up (YES of step S26), whether the swing direction is left or right is determined (step S27). The procedure moves to process F13 when the swing direction is left and the procedure moves to process F14 when the swing direction is right.

In process F13, whether any settings are present in the left swing starting up setting unit 32 is determined (step S28). When some settings are present (YES of step S28), the application C that is set to be started up is read (step S29) and the application C is started up on the full screen of the displaying screen 48 of the displaying unit 14 and is activated (step S30). When no settings are present in the left swing starting up setting unit 32 (NO of step S28), an application that is currently executed on a front screen (the application B that is activated in process F11) is obtained (step S31) and the application is displayed on the full screen of the displaying screen 48 of the displaying unit 14 (step S32).

In process F14, whether any settings are present in the right swing starting up setting unit 34 is determined (step S33). When some settings are present (YES of step S33), the application D that is set to be started up is read (step S34) and the application D is started up on the full screen of the displaying screen 48 of the displaying unit 14 and is activated (step S35). When no settings are present in the right swing starting up setting unit 34 (NO of step S33), an application that is currently executed on the front screen (the application B that is activated in process F11) is obtained (step S36) and the application is displayed on the full screen of the displaying screen 48 of the displaying unit 14 (step S37).

At step S26, when the input is not swing starting up (NO of step S26), the procedure moves to process F15. In process F15, whether any key input is present is determined (step S38). When some key input is present (YES of step S38), the key input is reflected on the above application that is activated (that is, the application B, the application C, or the application D) (step S39) and the procedure returns to step S22. When no key input is present (NO of step S38), the procedure also returns to step S22. That is, the reflection of the key input (step S39) is executed for the application B when the application B is currently started up, for the application C when the application Cis currently started up, or for the application D when the application D is currently started up, and input information of the key input is displayed on the displaying screen 48 of the application B, C, or D that is currently started up.

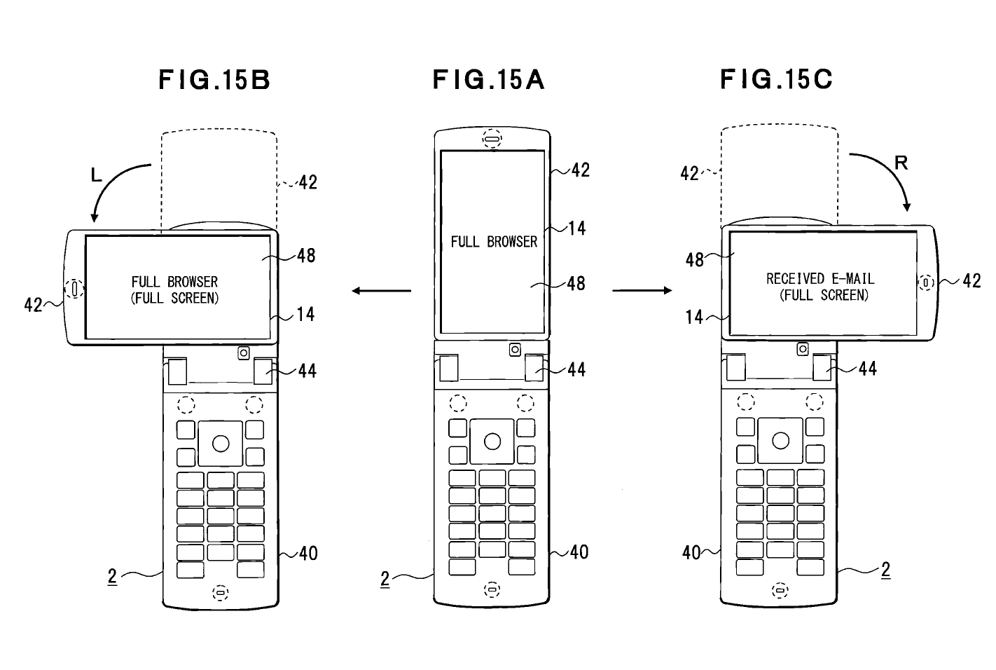

In the process procedure, when the application B is a full browser, the displaying screen 48 displays the full browser in the portrait-orientation screen as depicted in FIG. 15A. In the case where no starting-up information is set in the left swing starting up setting unit 32, when the display-side housing unit 42 is swung to the left, as depicted in FIG. 15B, the full browser that is currently started up is displayed on the full screen. When starting up settings of received e-mail as the application D are present in the right swing starting up setting unit 34, as depicted in FIG. 15C, the received e-mail of the application D is started up and is displayed on the full screen.

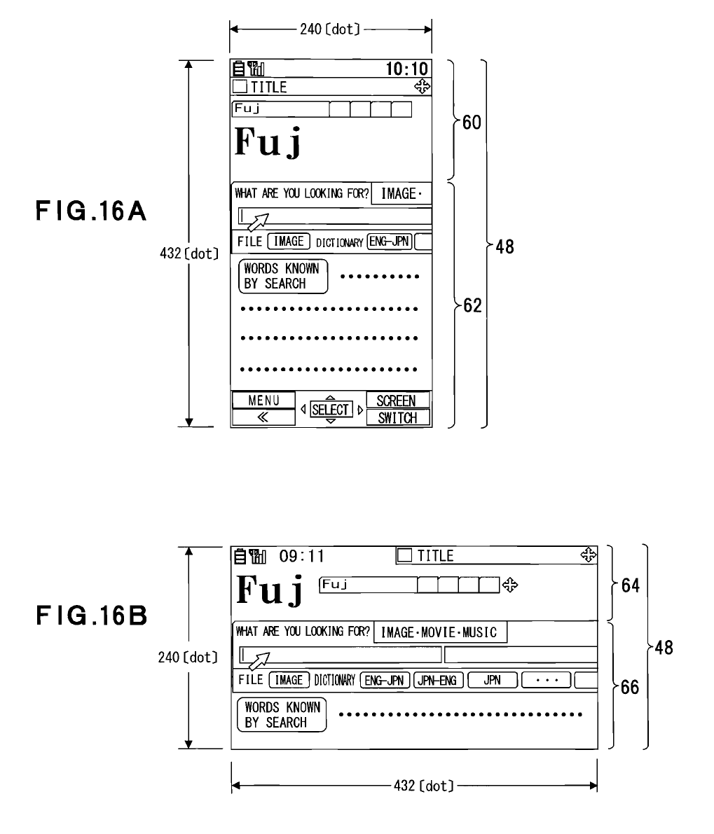

In this case, as depicted in FIG. 16A, the full browser is displayed in the portrait-orientation screen display of the displaying screen 48. In the display of the full browser, display information such as a title is displayed in a displaying area 60 and search result information searched for by the full browser is displayed in a displaying area 62. When the display is switched from the portrait-orientation screen display to the full-screen display of the landscape-orientation screen of the displaying screen 48, as depicted in FIG. 16B, display information such as a title is displayed in a displaying area 64 and search result information searched for by the full browser is displayed in a displaying area 66. The display width is expanded to 432 [dots] in the landscape-orientation screen display compared to the portrait-orientation screen display whose display width is 240 [dots] and is narrow, that is, a content displaying area is laterally expanded as the result of the swing operation and, therefore, simplification of grasp of the search result information is facilitated and the search result information becomes readable.

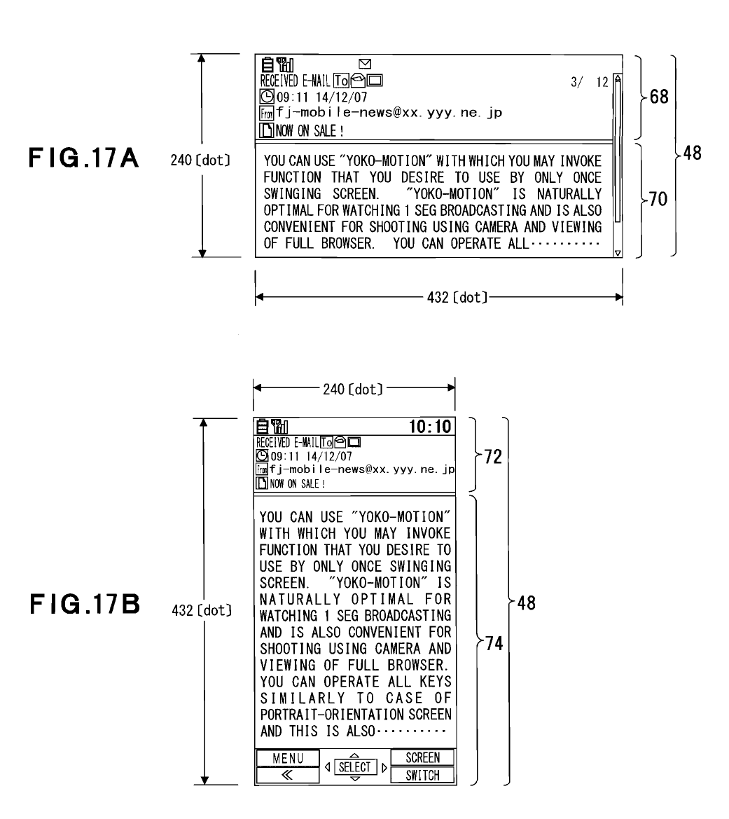

As depicted in FIG. 17A, the received e-mail of the application D that is started up by the right swing is displayed on the full screen. The time and date of the reception, e-mail address, etc., are displayed in a displaying area 68 and a text of the e-mail is displayed in a displaying area 70. The display width of the displaying area 70 is 432 [dots] and is wide because the display width is laterally expanded and the number of characters displayed in one line is increased as the result of the swing operation. In the portrait-orientation screen display, as depicted in FIG. 17B, similarly, the time and date of the reception, an e-mail address, etc., are displayed in a displaying area 72 and a text of the e-mail is displayed in a displaying area 74. However, the display width of the text of the e-mail is 240 [dots] and is narrow. Therefore, simplification of grasp of the text of the e-mail is facilitated in the portrait-orientation screen display and the text becomes readable.

### Second Example

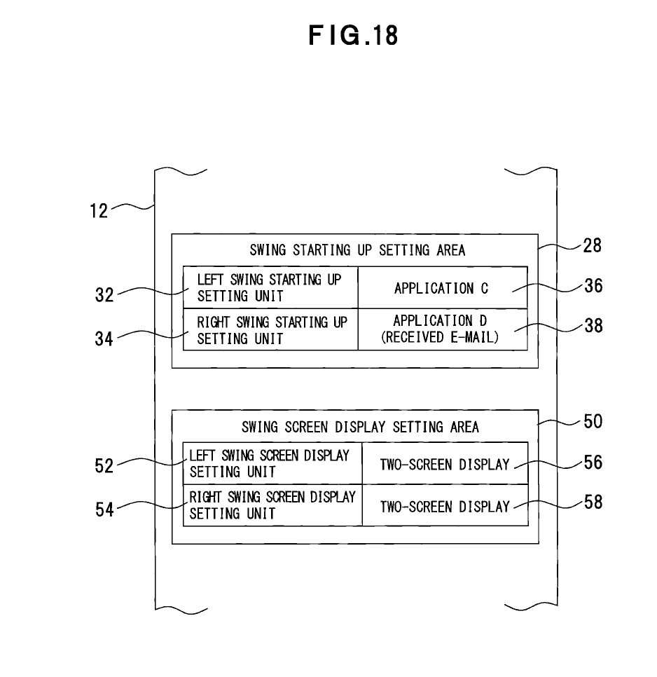

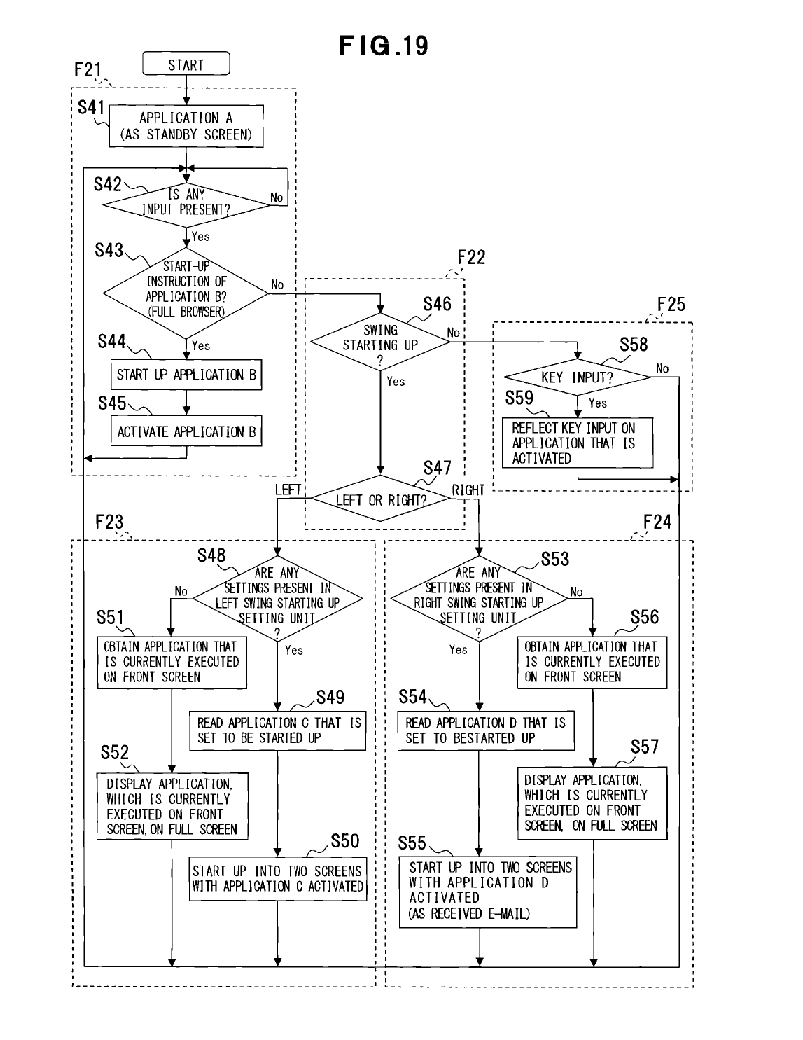

A second example will be described with reference to FIGS. 18 and 19. FIG. 18 is a diagram of storage information of a swing starting up setting area and a swing screen display setting area according to the second example. FIG. 19 is a flowchart of a process procedure according to the second example. The configurations depicted in FIGS. 18 and 19 are examples and the present invention is not limited to such configuration and process procedure. In FIG. 18, the same parts as those of FIG. 9 are given the same reference numerals.

The portable apparatus 2 according to the second example is the portable apparatus of the second embodiment (FIG. 8) that is embodied and facilitates activation that enables input, etc., on a display screen of the application that is started up later. To start up the application C by a left swing, as depicted in FIG. 18, the starting-up information 36 of the application C only has to be set in the left swing starting up setting unit 32 of the swing starting up setting area 28. To start up the application D (received e-mail) by a right swing, the starting-up information 38 of the application D only has to be set in the right swing starting up setting unit 34. To display an application that is currently started up in the two-screen display, the pieces of screen display information 56 and 58 that indicate the two-screen display only have to be stored in the left and right swing screen display setting units 52 and 54 of the swing screen display setting area 50. These pieces of information only have to be input when the portable apparatus 2 is started up and the setting information input mode is started up from the menu screen.

The process procedure of this example is an example of processing of the display control method and the display control program of the portable apparatus and includes, as depicted in FIG. 19: a shifting process from the application A in the standby to the application B that is the first application (process F21); a checking process of a swing operation (process F22); a starting-up process of the application C that is the second application by a swing operation to the left (process F23); a starting-up process of the application D that is the other second application by a swing operation to the right (process F24); and a key input process (process F25). In the processes, the application A is, for example, a program that starts up the standby screen, etc., the application B is, for example, a full browser (software to view data and contents of files, a browser), and the application D is, for example, e-mail software.

In process F21, the application A is started up triggered by turning on of the power (step S41) and the standby screen is displayed on the display screen 48 of the displaying unit 14. Whether any input is present from the standby screen is determined (step S42). When no input is present (NO of step S42), the standby state is maintained until any input is present. The input also includes the detection information of the swing state detecting unit 16. When some input is present (YES of step S42), whether the input is a start-up instruction of the application B is determined (step S43). When the input is a start-up instruction of the application B (YES of step S43), the application B is started up (step S44) and the application B is activated, that is, executed (step S45) and the procedure returns to step S42.

When the input at step S42 is not a start-up instruction of the application B at step S43 (NO of step S43), the procedure moves to process F22. In process F22, whether the input is swing starting up based on a swing operation is determined (step S46). When the input is swing starting up (YES of step S46), whether the swing direction is left or right is determined (step S47). The procedure moves to process F23 when the swing direction is left and the procedure moves to process F24 when the swing direction is right.

In process F23, whether any settings are present in the left swing starting up setting unit 32 is determined (step S48). When some settings are present (YES of step S48), the application C that is set to be started up is read (step S49) and the application C is started up. In this example, the displaying screen 48 is started up into the two screens with the application C activated (step S50). When no settings are present in the left swing starting up setting unit 32 (NO of step S48), the application that is currently executed on the front screen (the application B that is activated in process F21) is obtained (step S51) and the application is displayed on the full screen of the displaying screen 48 of the displaying unit 14 (step S52).

In process F24, whether any settings are present in the right swing starting up setting unit 34 is determined (step S53). When some settings are present (YES of step S53), the application D that is set to be started up is read (step S54) and the application D is started up. In this example, the displaying screen 48 is started up into the two screens (display of received e-mail) with the application D activated (step S55). When no settings are present in the right swing starting up setting unit 34 (NO of step S53), an application that is currently executed on the front screen (the application B that is activated in process F21) is obtained (step S56) and the application is displayed on the full screen of the displaying screen 48 of the displaying unit 14 (step S57).

At step S46, when the input is not swing starting up (NO of step S46), the procedure moves to process F25. In process F25, whether any key input is present is determined (step S58). When some key input is present (YES of step S58), the key input is reflected on the above application that is activated (that is, the application B, C, or D) (step S59) and the procedure returns to step S42. When no key input is present (NO of step S58), the procedure also returns to step S42. That is, as above, the reflection of the key input (step S59) is executed for the application B when the application B is currently started up, for the application C when the application C is currently started up, or for the application D when the application D is currently started up. Input information of the key input is displayed on the displaying screen 48 of the application B, C, or D that is currently started up.

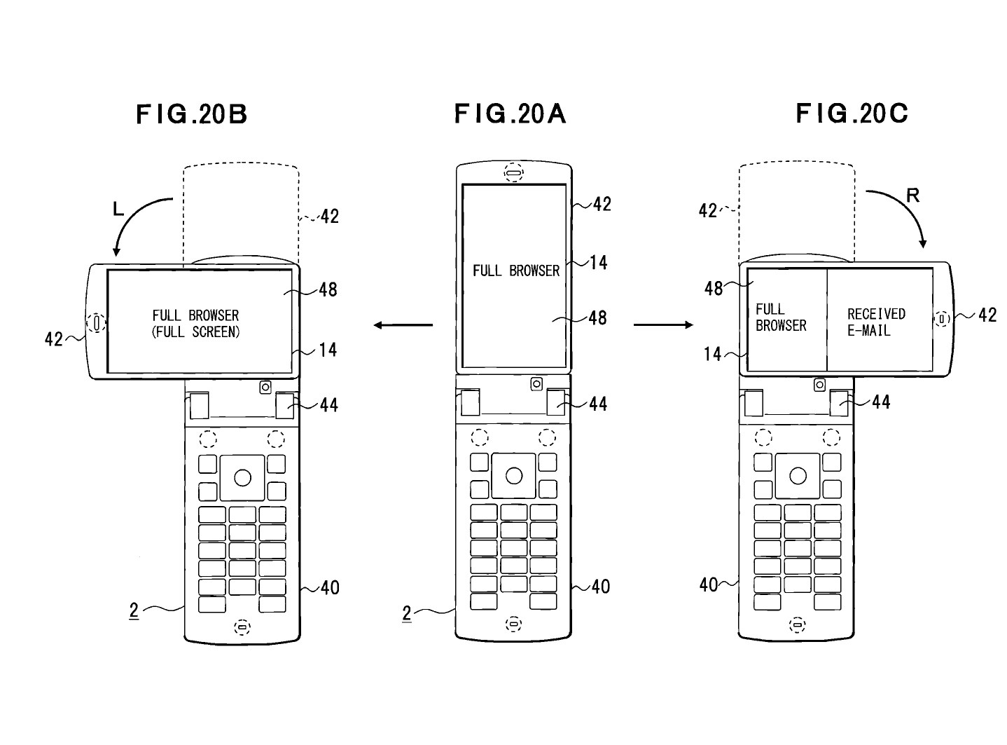

In this process procedure, when the application B is a full browser, the displaying screen 48 displays the full browser in the portrait-orientation screen as depicted in FIG. 20A. In the case where no starting-up information is set in the left swing starting up setting unit 32, when the display-side housing unit 42 is swung to the left, the full browser that is currently started up is displayed on the full screen as depicted in FIG. 20B. When starting up settings of received e-mail as the application D are present in the right swing starting up setting unit 34 and two-screen display settings are present in the right swing screen display setting unit 54, the two-screen display is executed of the full browser and the received e-mail of the application D as depicted in FIG. 20C.

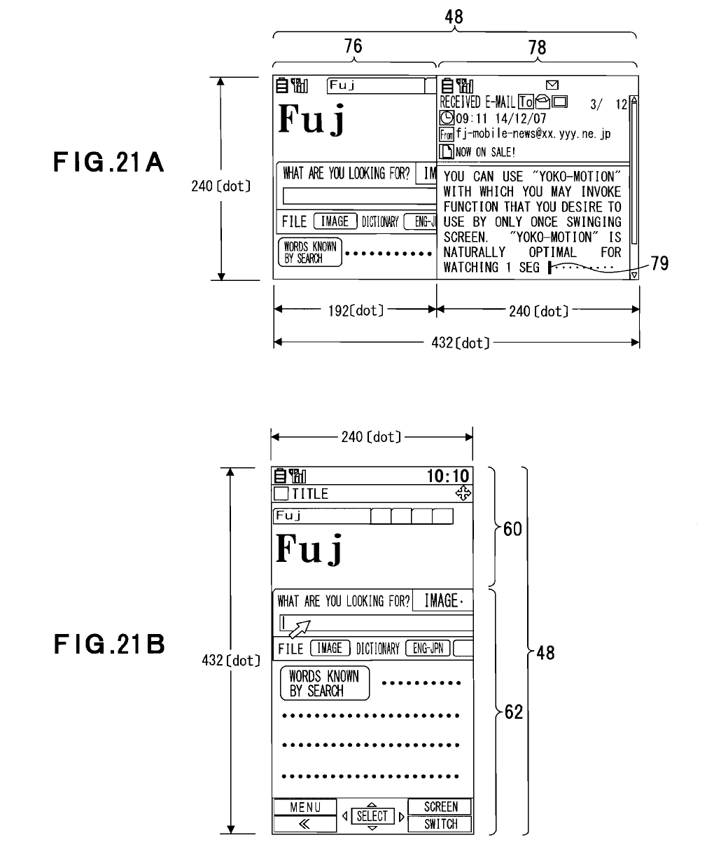

In the two-screen display of the received e-mail of the application D that is started up by the right swing and the full browser, as depicted in FIG. 21A, the full browser is displayed in a displaying area 76 whose landscape-orientation screen has a lateral width of 192 [dots], the received e-mail is displayed in a displaying area 78 having a lateral width of 240 [dots], and a cursor 79 is displayed in the received e-mail that is activated. As depicted in FIG. 21B, in the portrait-orientation screen display, only the text of the e-mail is displayed. In contrast, in the two-screen display, the two pieces of information that are the received e-mail and the full browser may be grasped on one screen and this is highly convenient.

Key input information is reflected by key input on the text of the e-mail in the displaying area 78 depicted in FIG. 21A, and creation and editing of response e-mail to the received e-mail may be executed by key input.

### Third Example

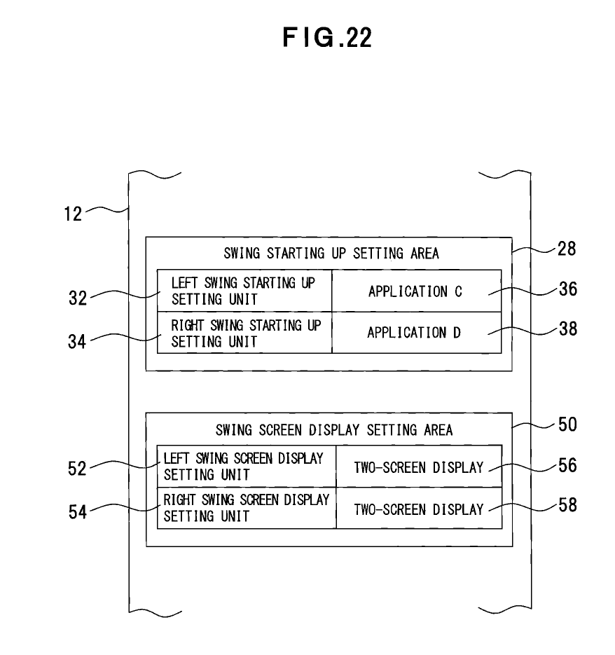

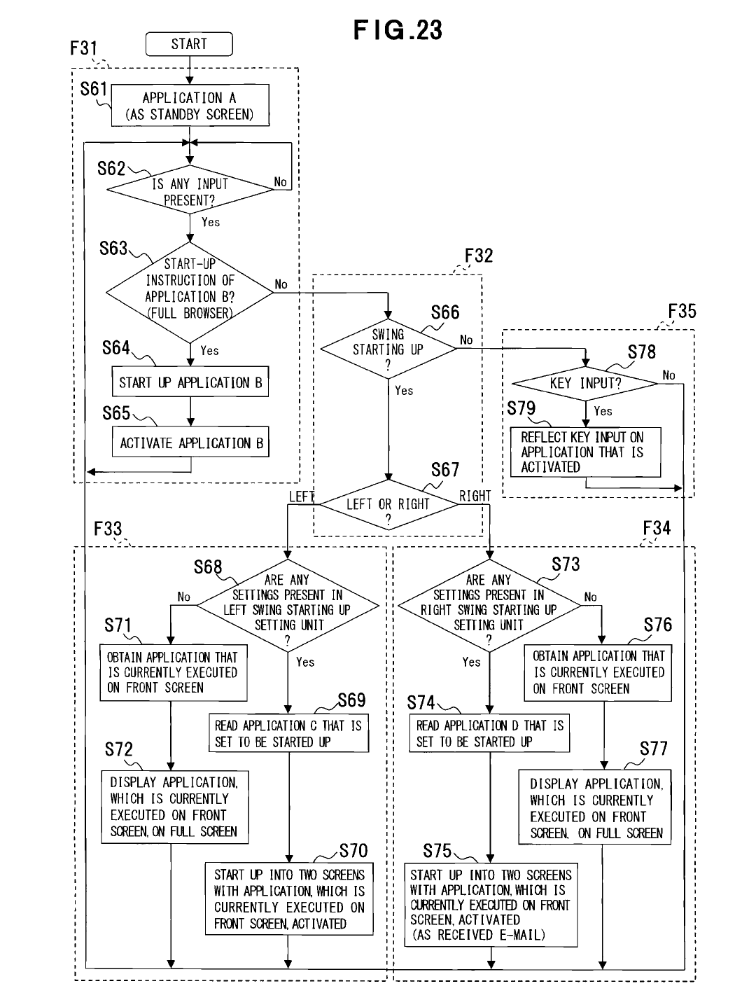

A third example will be described with reference to FIGS. 22 and 23. FIG. 22 is a diagram of storage information of a swing starting up setting area and a swing screen display setting area according to the third example. FIG. 23 is a flowchart of a process procedure according to the third example. The configurations depicted in FIGS. 22 and 23 are examples and the present invention is not limited to such configuration and the process procedure. In FIG. 22, the same parts as those of FIG. 9 are given the same reference numerals.

The portable apparatus 2 according to the third example is the portable apparatus of the second embodiment (FIG. 8) that is embodied and that, when two screens are displayed for an application that is started up later and an application that is started up earlier, facilitates activation to enable input, etc., on the screen of the application started up earlier, on the screens. To start up the application C by a left swing, as depicted in FIG. 22, the starting-up information 56 of the application C only has to be set in the left swing starting up setting unit 32 of the swing starting up setting area 28. To start up the application D by a right swing, the starting-up information 58 of the application D only has to be set in the right swing starting up setting unit 34. To display an application that is currently started up in the two-screen display, the pieces of screen display information 56 and 58 that are indicative of the two-screen display only have to be stored in the left and the right swing screen display setting units 52 and 54 of the swing screen display setting area 50 or, though not depicted, the full-screen display may be set in the left swing screen display setting unit 52. These pieces of information may be input when the portable apparatus 2 is started up and the setting information input mode is started up from the menu screen.

The process procedure of this example is an example of processing of the display control method and the display control program of the portable apparatus and includes, as depicted in FIG. 23: a shifting process from the application A in the standby state to the application B that is the first application (process F31); a checking process of a swing operation (process F32); a process of the application B that is currently executed by a left swing operation, or a starting up process of the application C that is the second application and starting up of the two screens (process F33); a process of the application B that is currently executed triggered by a right swing operation, or a starting up process of the application D that is the other second application and starting up of the two screens (process F34); and a key input process (process F35). In the processes, the application A is, for example, a program that starts up the standby screen, etc., the application B is, for example, a full browser (software to view data and contents of files, a browser), and the application D is, for example, e-mail software.

In process F31, the application A is started up triggered by turning on of the power (step S61) and the standby screen is displayed on the displaying screen 48 of the displaying unit 14. Whether any input is present from the standby screen is determined (step S62). When no input is present (NO of step S62), the standby state is maintained until any input is present. The input also includes the detection information of the swing state detecting unit 16. When some input is present (YES of step S62), whether the input is a start-up instruction of the application B is determined (step S63). When the input is a start-up instruction of the application B (YES of step S63), the application B is started up (step S64) and the application B is activated, that is, executed (step S65) and the procedure returns to step S62.

When the input at step S62 is not a start-up instruction of the application B at step S63 (NO of step S63), the procedure moves to process F32. In process F32, whether the input is swing starting up based on a swing operation is determined (step S66). When the input is swing starting up (YES of step S66), whether the swing direction is left or right is determined (step S67). The procedure moves to process F33 when the swing direction is left and the procedure moves to process F34 when the swing direction is right.

In process F33, whether any settings are present in the left swing starting up setting unit 32 is determined (step S68). When some settings are present (YES of step S68), the application C that is set to be started up is read (step S69) and the application C is started up together with the application B that is currently started up. In the example, the displaying screen 48 is started up into the two screens with the application B that is currently executed on the front screen activated and the two-screen display of the applications B and C is executed (step S70).

When no settings are present in the left swing starting up setting unit 32 (NO of step S68), the application that is currently executed on the front screen (the application B that is activated in process F31) is obtained (step S71) and the application is displayed on the full screen of the displaying screen 48 of the displaying unit 14 (step S72).

In process F34, whether any settings are present in the right swing starting up setting unit 34 is determined (step S73). When some settings are present (YES of step S73), the application D that is set to be started up is read (step S74) and the application D is started up together with the application B that is currently started up. In the example, the displaying screen 48 is started up into the two screens with the application B that is currently executed on the front screen activated and two-screen display of the applications B and D is executed. In this case, the received e-mail is displayed on one of the two screens displayed (step S75).

When no settings are present in the right swing starting up setting unit 34 (NO of step S73), an application that is currently executed on the front screen (the application B that is activated in process F31) is obtained (step S76) and the application is displayed on the full screen of the displaying screen 48 of the displaying unit 14 (step S77).

At step S66, when the input is not swing starting up (NO of step S66), the procedure moves to process F35. In process F35, whether any key input is present is determined (step S78). When some key input is present (YES of step S78), the key input is reflected on the above application that is activated (that is, the application B, C, or D) (step S79) and the procedure returns to step S62. When no key input is present (NO of step S78), the procedure also returns to step S62. That is, as above, the reflection of the key input (step S79) is executed for the application B when the application B is currently started up, for the application C when the application Cis currently started up, or for the application D when the application D is currently started up. Input information of the key input may be displayed on the displaying screen 48 of the application B, C, or D that is currently started up.

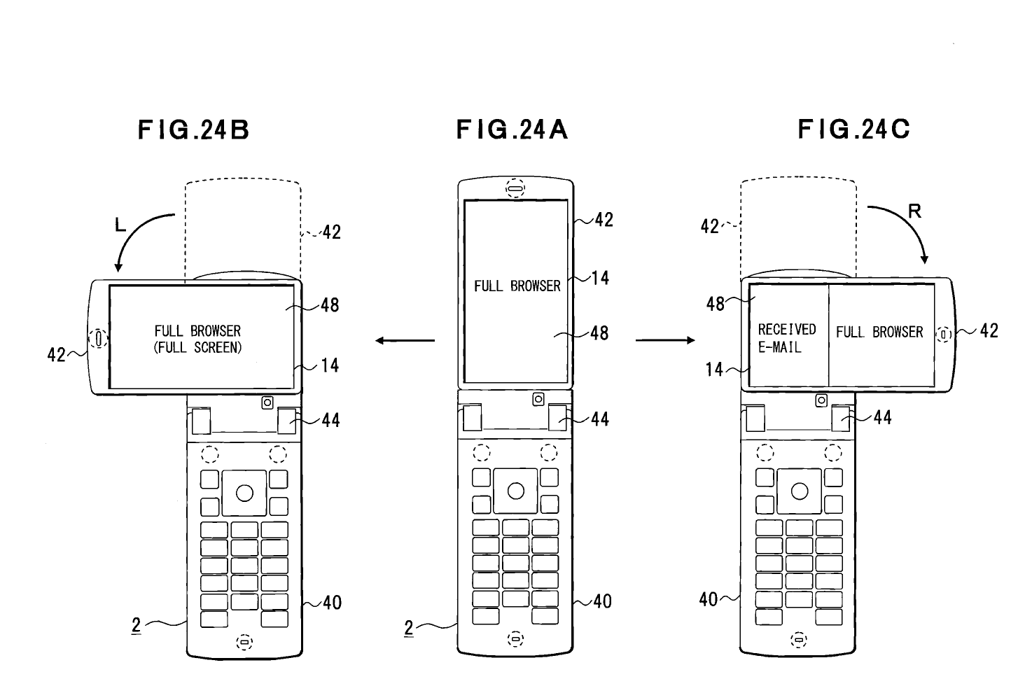

In this process procedure, when the application B is a full browser, the displaying screen 48 displays the full browser in the portrait-orientation screen as depicted in FIG. 24A. In the case where no starting-up information is set in the left swing starting up setting unit 32, when the display-side housing unit 42 is swung to the left, as depicted in FIG. 24B, the full browser that is currently started up is displayed on the full screen. When starting up settings of received e-mail as the application D are present in the right swing starting up setting unit 34 and two-screen display settings are present in the right swing screen display setting unit 54, the two-screen display of the full browser and the received e-mail of the application D is executed as depicted in FIG. 24C.

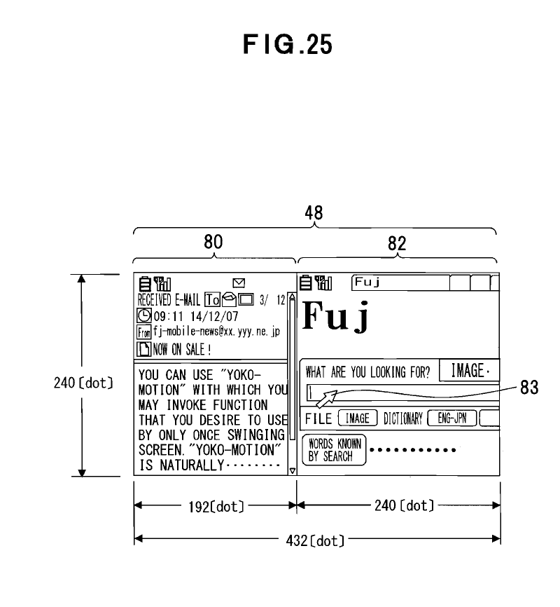

As depicted in FIG. 25 that corresponds to FIG. 24C, in the two-screen display of the received e-mail of the application D started up by the right swing and the full browser, the received e-mail is displayed in a display area 80 that is the landscape-orientation screen having a lateral width of 192 [dots] and the full browser is displayed in a display area 82 having a lateral width of 240 [dots], and a cursor 83 is displayed on the full browser display that is activated. On such two-screen display, two pieces of information that are the received e-mail and the full browser may be grasped on one screen and this is highly convenient.

As depicted in FIG. 25, on the full browser display in the display area 82, the cursor 83 is movable, key input information may be reflected by the key input, and a full browser process is executable.

### Fourth Example

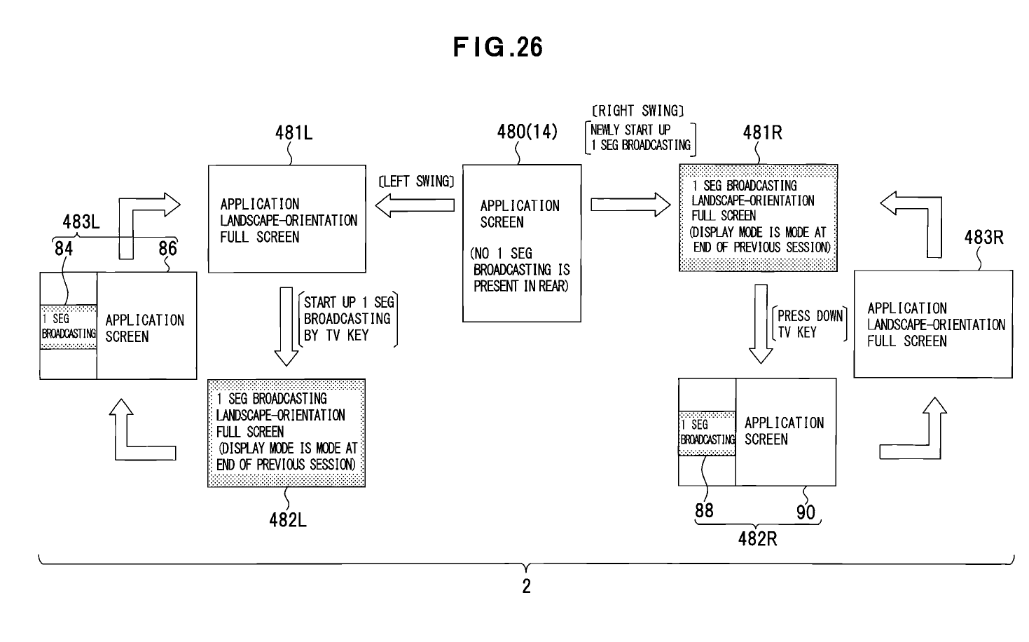

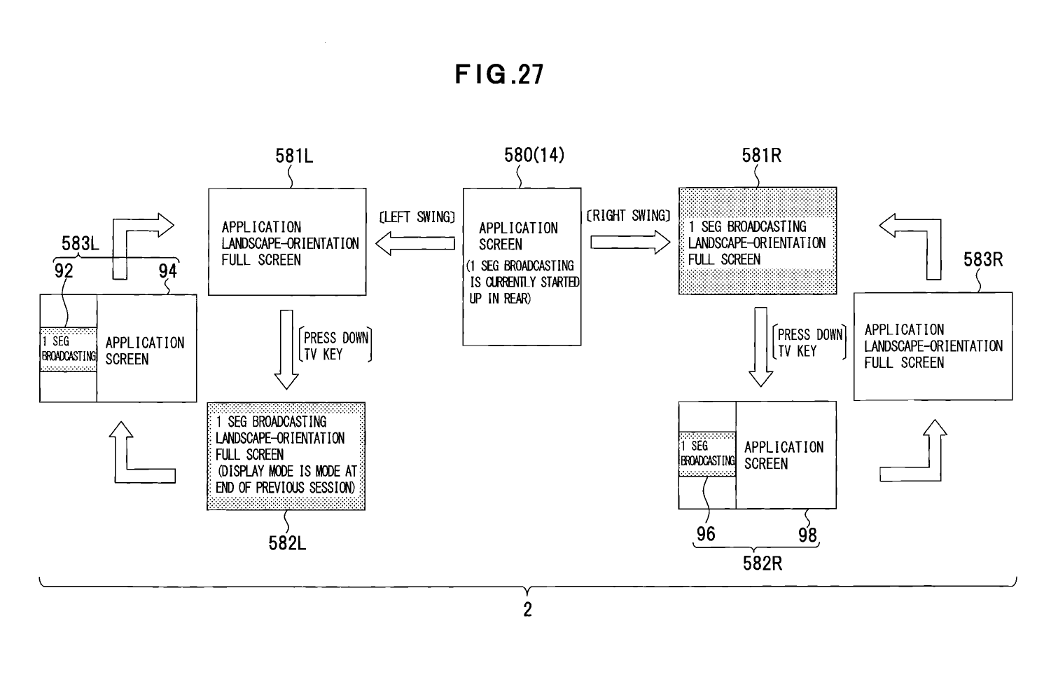

A fourth example will be described with reference to FIGS. 26 and 27. FIGS. 26 and 27 are diagrams of starting up of applications and switching of display screens according to the fourth example. The configurations depicted in FIGS. 26 and 27 are examples and the present invention is not limited to such configuration and process procedure.

In the fourth example, in a display mode of the portrait-orientation screen display of the portable apparatus 2, when a display screen of an application is currently started up, switching of a 1 Seg broadcasting reception screen is executed from the state where no display of any 1 Seg broadcasting reception screen is present. As depicted in FIG. 26: the displaying screen 48 on which an application of the portable apparatus 2 is started up is switched by a left swing of the displaying unit 14 from a portrait-orientation screen (application screen) 480 to an application landscape-orientation full screen 481L; when the TV key 606 (FIG. 4) is pressed down from the display of the application landscape-orientation full screen 481L, the display mode is switched to a 1 Seg broadcasting reception mode; and, when reception of 1 Seg broadcasting is started, a 1 Seg broadcasting landscape-orientation full screen 482L is displayed. This display mode may be a mode at the end of the previous session.

The 1 Seg broadcasting reception mode is executed by the first pressing down of the TV key 606 (FIG. 4) and, after the starting up of the 1 Seg broadcasting reception mode, the display is switched to the two-screen display and the application landscape-orientation full screen display by the next sequential pressing down of the TV key 606 . In this case, a 1 Seg broadcasting reception screen 84 and an application screen 86 are displayed on a landscape-orientation screen 483L and the application landscape-orientation full screen 481L is restored by the next pressing down of the TV key 606.

The portable apparatus 2 may be adapted to: switch the displaying screen 48 to a 1 Seg broadcasting landscape-orientation full screen 481R when the display unit 14 is swung to the right from the portrait-orientation screen (application screen) 480 on which an application is started up; display a 1 Seg broadcasting reception screen 88 and an application screen 90 on a landscape-orientation screen 482R when the TV key 606 (FIG. 4) is pressed down from the display of the 1 Seg broadcasting landscape-orientation full screen 481R; shift the display to an application landscape-orientation full screen 483R by the next pressing down of the TV key 606; and restore the 1 Seg landscape-orientation full screen 481R by the next pressing down of the TV key 606. The 1 Seg landscape-orientation full screen 481R may also be adapted to set its mode to be a mode at the end of the previous session.

In this case, the TV key 606 is used to switch the display from the 1 Seg landscape-orientation full screen 482L to the landscape-orientation screen 483L and from the landscape-orientation screen 483L to the application landscape-orientation full screen 481L. However, the switching may also be executed assigning the functions of the function switching and the display switching to another key. The TV key 606 is also used to switch the display from the landscape-orientation screen 482R to the application landscape-orientation full screen 483R and from the application landscape-orientation full screen 483R to the 1 Seg broadcasting landscape-orientation full screen 481R. However, the switching of the display may also be executed assigning the function of the display function switching to another key.

As depicted in FIG. 27, on a portrait-orientation screen 580 on which an application is started up (application screen), the 1 Seg broadcasting reception may also currently be started up. In this case, in the case where the displaying unit 14 is swung to the left, when the displaying screen 48 is switched to an application landscape-orientation full screen 581L and the TV key 606 (FIG. 4) is pressed down from the display of the application landscape-orientation full screen 581L, the 1 Seg broadcasting reception mode is started up and a 1 Seg broadcasting landscape-orientation full screen 582L thereof is displayed. That is, the displaying unit 14 may also be adapted to display, after the 1 Seg broadcasting is started up, two screens that are a 1 Seg broadcasting reception screen 92 and an application screen 94 on a landscape-orientation screen 583L with sequentially pressing down of the TV key 606, and restore the application landscape-orientation full screen 581L with the next pressing down of the TV key 606.

The displaying unit 14 may also be adapted to: when the displaying unit 14 is swung to the right from the portrait-orientation screen 580 on which an application is started up (application screen), switch the displaying screen 48 to a 1 Seg broadcasting landscape-orientation full screen 581R; with pressing down of the TV key 606 (FIG. 4) from the display of the 1 Seg broadcasting landscape-orientation full screen 581R, display a 1 Seg broadcasting reception screen 96 and an application screen 98 on a landscape-orientation screen 582R; shift the display to an application landscape-orientation full screen 583R with the next pressing down of the TV key 606; and restore the 1 Seg broadcasting landscape-orientation full screen 581R with the next pressing down of the TV key 606.

### Other Examples

In the above examples, a received e-mail list set in the right swing starting up settings may be started up when a right swing is executed during the operation of the full browser, and the full browser full screen display may be executed triggered by a left swing.

In the above examples, two-screen display of the full browser operated and the received e-mail list set in the right swing starting up settings may also be enabled when a right swing is executed during the operation of the full browser, and the full browser full screen display may also be executed triggered by a left swing.

In the above examples, concerning an application that is displayed on a portrait-orientation screen, even when the screen for the application is switched to a landscape-orientation screen, the display area of the lateral width is not changed and another application that is started up using the swing starting up settings may be displayed in the remaining area.

In the above examples, whether which screen is used for the two screens or the full screen with a left or a right swing may be made arbitrarily selectable with a key.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

The technical ideas extracted from the above embodiments of the present invention will be listed. The technical ideas according to the present invention may be grasped at various levels and in various variations from a generic concept to a more limitative concept. Therefore, the present invention is not limited by the following description.

A portable apparatus that is capable of concurrently executing two or more applications includes a housing unit that is capable of swinging to left or right; a displaying unit that is installed in the housing unit, the displaying unit displaying a displaying screen of an application that is currently started up; a swing state detecting unit that detects a swing state of the displaying unit; a swing starting up setting unit that is set therein with an application to be started up by one of or both of the swings to the left and the right, and the display information of the application; and a control unit that, during starting up of a first application, starts up a second application set in the swing starting up setting unit based on detection information that is indicative of the swing state of the displaying unit detected by the swing state detecting unit, the control unit changing display on the displaying unit from display before the swing to display of the second application started up after the swing.

According to such configurations: the swing starting up setting unit may be set therein with the second application to be started up and the display information; a left or a right swing may be detected during the starting up of the first application; and, based on the second application and the display information set in the swing starting up setting unit, the starting up of the application and screen display based on the display information set may be executed.

In the above portable apparatus, preferably, the control unit may be capable of starting up a plurality of applications, and display two screens that are a display screen of the first application being currently started up on the displaying unit before a swing operation and a display screen based on the second application set in the swing starting up setting unit on the displaying unit after the swing operation. The above portable apparatus may include an input operating unit to execute an input operation, wherein the control unit may accept input from the input operating unit while two screens are displayed on the displaying unit, and reflect the input on the display screen of the second application that is started up by a swing operation of the displaying unit. The above portable apparatus may include an input operating unit to execute an input operation, wherein the control unit may accept input from the input operating unit while two screens are displayed on the displaying unit, and reflect the input on the display screen of the first application.

A display control method of a portable apparatus that is capable of concurrently executing two or more applications includes setting an application to be started up by one of or both of swings to left and right, and display information of the application; swinging a displaying unit that displays a display screen of an application currently started up; detecting a swing state; and starting up, while a first application is started up, a second application set, based on detection information that is indicative of the swing state, and changing from a display screen before the swing to a display screen of the second application started up after the swing.

According to such configuration, because the second application to be started up and the display information may be set, based on the detection of a left or a right swing during the starting up of the first application, the starting up of the second application and the screen display based on the display information may be executed using the second application and the display information.

The above display control method of a portable apparatus may preferably include executing two-screen display that is capable of starting up thereon a plurality of applications, and that is configured by a display screen of the first application currently started up on the displaying unit before a swing operation and a display screen based on the starting up of the second application on the displaying unit after the swing operation. The above display control method may include accepting input from an input operating unit while two screens are displayed on the displaying unit, and reflecting the input on the display screen of the second application that is started up by a swing operation of the displaying unit. In the above display control method, input from an input operating unit may be accepted while two screens are displayed on the displaying unit and the input may be reflected on the display screen of the first application.

According to the embodiments of the present invention, the following effects may be obtained.

(1) The swing starting up setting unit may be set therein with an application to be started up based on a swing and the display information and, therefore, another application may be started up in response to a swing operation separately from the application that is currently started up, and the screen display corresponding to the display information set may be executed. Therefore, the degree of freedom of each of starting up of applications and the screen display may be increased and the convenience of the portable apparatus may be improved.

(2) An application to be started up in response to a swing operation and the screen display corresponding to the application may be selected and set and, therefore, the convenience of the portable apparatus may be improved.

As above, the most preferred embodiments, etc., of the present invention have been described. However, the present invention is not limited by the above description, and those skilled in the art may naturally make various modifications and changes thereto based on the gist of the present invention that is described in claims and disclosed herein and, not to mention, such modifications and changes are encompassed within the scope of the present invention.

Each of the embodiments of the present invention is a portable apparatus that may concurrently execute two or more applications and the function of receiving 1 Seg broadcasting, that may set therein with an application to be started up when a left or a right swing is executed during starting up of another application, and its screen form, and that may change starting up of an application and its screen form using a swing operation. Therefore, the degree of freedom of each of starting up of an application and the screen display may be increased and the convenience of the portable apparatus may be improved. Therefore, each of the embodiments may be applied to a portable PC, etc., in addition to a portable telephone apparatus and a PDA, and is useful.

What is claimed is:

1. A portable apparatus that is capable of concurrently executing two or more applications, comprising:
a housing unit that is capable of swinging to left or right;
a displaying unit that is installed in the housing unit, the displaying unit displaying a displaying screen of an application that is currently started up;
a swing state detecting unit that detects a swing state of the displaying unit;
a swing starting up setting unit that is set therein with an application to be started up by one of or both of the swings to the left and the right, and the display information of the application; and
a control unit that, during starting up of a first application, starts up a second application set in the swing starting up setting unit based on detection information that is indicative of the swing state of the displaying unit detected by the swing state detecting unit, the control unit changing display on the displaying unit from display before the swing to display of the second application started up after the swing.

2. The portable apparatus of claim 1, wherein
the control unit is capable of starting up a plurality of applications, and displays two screens that are a display screen of the first application being currently started up on the displaying unit before a swing operation and a display screen based on the second application set in the swing starting up setting unit on the displaying unit after the swing operation.

3. The portable apparatus of claim 1, further comprising
an input operating unit to execute an input operation, wherein
the control unit accepts input from the input operating unit while two screens are displayed on the displaying unit, and reflects the input on the display screen of the second application that is started up by a swing operation of the displaying unit.

4. The portable apparatus of claim 1, further comprising
an input operating unit to execute an input operation, wherein
the control unit accepts input from the input operating unit while two screens are displayed on the displaying unit, and reflects the input on the display screen of the first application.

5. A display control method of a portable apparatus that is capable of concurrently executing two or more applications, comprising:
setting an application to be started up by one of or both of swings to left and right, and display information of the application;
swinging a displaying unit that displays a display screen of an application currently started up;
detecting a swing state; and
starting up, while a first application is started up, a second application set, based on detection information that is indicative of the swing state, and changing from a display screen before the swing to a display screen of the second application started up after the swing.

6. The display control method of a portable apparatus of claim 5, further comprising
executing two-screen display that is capable of starting up thereon a plurality of applications, and that is configured by a display screen of the first application currently started up on the displaying unit before a swing operation and a display screen based on the starting up of the second application on the displaying unit after the swing operation.

7. The display control method of a portable apparatus of claim 5, further comprising
accepting input from an input operating unit while two screens are displayed on the displaying unit, and reflecting the input on the display screen of the second application that is started up by a swing operation of the displaying unit.

8. The display control method of a portable apparatus of claim 5, wherein
input from an input operating unit is accepted while two screens are displayed on the displaying unit and the input is reflected on the display screen of the first application.
